(19) United States
(12) Patent Application Publication
(10) Pub. No.: US 2005/0198375 A1
(43) Pub. Date: Sep. 8, 2005

(54) Distributed multi-protocol label switching router and managing labels therein

(76) Inventors: Chul-Hoon Hwang, Suwon-si (KR); Byung-Gu Choe, Seoul (KR); Yong-Seok Park, Yongin-si (KR)

Correspondence Address: Robert E. Bushnell, Suite 300, 1522 K Street, N.W., Washington, DC, 20005-1202, US

(21) Appl. No.: 10/995,429

(22) Filed: Nov. 24, 2004

(30) Foreign Application Priority Data
Jan. 20, 2004 (KR) 2004-4527

(51) Int. Cl. G06F 15/173

(52) U.S. Cl. 709/238

(57) ABSTRACT

A distributed multi-protocol label switching router determines whether at least one extra label exists in a local label pool having information on allocated labels stored therein and requests allocation of the labels in preset units in a switching control card in response to a determination that no extra labels exists in response to a label allocation request to establish at least one label switched path in a subscriber line card. The labels are allocated at a label pool have information on all labels capable of being allocated in a distributed multi-protocol label switching router stored in preset units therein in response to the label allocation request of the subscriber line card in the switching control card, and the information of the allocated labels is transmitted to the subscriber line card. A label pool in the subscriber line card is updated according to information of the allocated labels transmitted from the switching control card, and the labels are allocated in the updated label pool in response to the label allocation request in the subscriber line card.

### CLAIM OF PRIORITY

This application makes reference to, incorporates the same herein, and claims all benefits accruing under 35 U.S.C. § 119 from an application for METHOD OF MANAGING LABELS OF DISTRIBUTED MULTI-PROTOCOL LABEL SWITCHING ROUTER AND DISTRIBUTED MULTI-PROTOCOL LABEL SWITCHING ROUTER USED IN THE SAME earlier filed in the Korean Intellectual Property Office on 20 Jan., 2004 and there duly allocated Ser. No. 2004-4527.

### BACKGROUND OF THE INVENTION

1. Field of the Invention

The present invention relates to a Multi-protocol Label Switching (MPLS) system and, more particularly, to a distributed MPLS router and managing labels therein.

2. Description of the Related Art

Currently, the number of Internet users is exponentially increasing. Furthermore, the users demand various services ranging from general data services, which are based on a best-effort service characterized by an existing Internet, to multimedia services, which require voice, moving pictures, etc. to guarantee Quality of Service (QoS) on the Internet. As technology suitable to transfer general data, the Internet is mainly based on an Ethernet such as a File Transfer Protocol (FTP).

Multi-protocol Label Switching (MPLS) has been developed to meet with the demands of the users such as real-time data transfer in an Internet environment. MPLS is a protocol between layer 2 and layer 3 of the communication protocol, and is technology capable of forwarding a packet at a high speed without any processing up to layer 3, by attaching a layer 2 label to a header of the packet and then forwarding the packet with reference to only the label attached to the MPLS header of the packet.

In other words, the MPLS classifies a same Forwarding Equivalence Class (hereinafter, referred to as an “FEC”) using the identical destination IP address as a key on the basis of a forwarding table generated by an existing routing protocol, and then endows a routing entry belonging to the same FEC with the same label. Thus, packets having the same destination have the same label, and are transmitted to the destination by label switching at a high speed.

In the MPLS, a path is set between a transmission side and a reception side, which is called a Label Switched Path (LSP). The LSP has a connection-oriented characteristic, so that it is possible to forward Internet traffic in real-time. A Border Gateway Protocol (BGP) or a Label Distribution Protocol (LDP) is used as the protocol for switching the labels.

In the switching network which is supported by the MPLS, each switch is called an MPLS router or a Label Switching Router (LSR).

Generally, for label switching, the MPLS router establishes the LSP using a value of the label established in a shim header, and forwards the packet with reference to the label value in an MPLS domain.

For this purpose, the MPLS router has a label manager for managing the label. When the MPLS router intends to request and allocate a certain label, the MPLS router allocates the label among from an allocatable label pool which is managed by the label manager.

Typically, when the MPLS router requests and allocates the label in order to establish the LSP, the MPLS router determines if the label can be requested through the label manager, and then allocates the label.

A distributed MPLS router supports an MPLS function at each line card installed in the LSR, and conducts distributed processing of data packets, control signals and so forth, and more particularly, conducts distributed processing at each line card when a signal protocol such as an Resource Reservation Protocol-traffic Engineering (RSVP-TE) protocol is used.

The distributed MPLS router is generally equipped with switching control cards for performing a switching function and subscriber line cards. The subscriber line cards are divided into two categories: one of supporting the MPLS and the other not supporting the MPLS. Each subscriber line card supporting the MPLS includes an MPLS daemon to perform communication with the switching control card, generates a label manager for managing its own established label pool, and establishes its own allocated label pool in the label manager. When receiving a request from the outside, each subscriber line card can change its own allocated label pool.

Conventionally, the distributed MPLS router is designed to inflexibly divide and allocate the labels between each subscriber line card on the basis of the number of subscriber line cards, so that it is impossible to perform automatic re-adjustment of the labels, and thus it is only possible to perform automatic re-adjustment of the labels by a command of an operator.

An MPLS shim header, for example, is composed of an Ethernet header, a Shim header and a Layer-3 header, wherein the shim header has 32 bits and consists of Label (20 bits), EXP (Experimental Use, 3 bits), Stack bits (Bottom of Stack, 1 bit) and TTL (Time to Live, 8 bits). Each label consists of 20 bits and has a range between 0 (zero) and 1048575 (2²⁰−1) which can be used in theory. Thus, except for the range between 0 and 15 which has been already reserved for a special application, the remaining range is between 16 and 1048575, which can be generally allocated by the label manager.

Thus, the label range per line card=1048575/the number of line cards.

For example, for 12 line cards
1048575/12=87381
Line card 0={16,87396} . . .

However, when the label range is allocated in this manner, the LSP defined through a specific subscriber line card can exceed a fixed allocated label range. If so, there is a problem in that the label range must again be allocated.

Furthermore, after the line card is fitted into an empty slot, a subsequent measure to allocate the label again must be taken. Nevertheless, since this subsequent measure is not taken, the label is destined for allocation in such a manner that it must be fixedly divided by the number of the slots into which the line cards may be fitted regardless of whether or not the line card is fitted and whether or not the MPLS protocol is operated. For this reason, there is another problem in that the unused label is allocated.

The following patents each discloses features in common with the present invention but do not teach or suggest the inventive features specifically recited in the present application: U.S. patent application No. 2003/0212927 to Navar et al., entitled FAULT-PROTECTION MECHANISM FOR PROTECTING MULTI-PROTOCOL-LABEL SWITCHING (MPLS) CAPABILITY WITHIN A DISTRIBUTED PROCESSOR ROUTER OPERATING IN AN MPLS NETWORK, published on Nov. 13, 2003; U.S. patent application No. 2003/0002444 to Shin et al., entitled ROUTE DETERMINING METHOD IN A MULTI PROTOCOL LABEL SWITCHING NETWORK, published on Jan. 2, 2003; U.S. patent application No. 2002/0071427 to Schneider et al., entitled MULTISERVICE USE OF NETWORK CONNECTION CAPABILITY, published on Jun. 13, 2002; U.S. patent application No. 2004/0125805 to De Clercq et al., entitled MULTIPROTOCOL LABEL SWITCHING LABEL DISTRIBUTION METHOD, A RELATED FIRST MULTIPROTOCOL LABEL SWITCHING NETWORK ELEMENTAND A RELATED SECOND MULTIPROTOCOL LABEL SWITCHING NETWORK ELEMENT, published on Jul. 1, 2004; and U.S. patent application No. 2004/0095922 to Sasagawa, entitled METHOD AND APPARATUS FOR INTERCONNECTING NETWORKS, published on May 20, 2004.

### SUMMARY OF THE INVENTION

It is, therefore, an object of the present invention to provide a distributed MPLS router and a method of managing labels therein, capable of effectively managing label resources by dynamically allocating labels, if necessary, at the distributed MPLS router.

In order to accomplish this object, according to one aspect of the invention, a method of managing labels of a distributed multi-protocol label switching (MPLS) router is provided, the method comprising: determining whether at least one extra label exists in a local label pool having information on allocated labels stored therein and requesting allocation of the labels in preset units in a switching control card in response to a determination that no extra labels exists in response to a label allocation request to establish at least one label switched path in a subscriber line card; allocating the labels at a label pool having information on all labels capable of being allocated in a distributed multi-protocol label switching router stored in preset units therein in response to the label allocation request of the subscriber line card in the switching control card, and transmitting the information of the allocated labels to the subscriber line card; and updating a label pool in the subscriber line card according to information of the allocated labels transmitted from the switching control card, and allocating the labels in the updated label pool in response to the label allocation request in the subscriber line card.

According to another aspect, a method of managing labels of a distributed multi-protocol label switching (MPLS) router is provided, the method comprising: determining whether at least one extra label exists in a label pool of a multi-protocol label switching client daemon and requesting a multi-protocol label switching server daemon installed on a switching control card to allocate a label in response to a determination that no extra label exists in response to the multi-protocol label switching client daemon installed on a subscriber line card receiving a label allocation request in a line card of the multi-protocol label switching client daemon; allocating, in the multi-protocol label switching server daemon, the labels stored in a label pool of the multi-protocol label switching server daemon to the corresponding multi-protocol label switching client daemon in page units composed of a plurality of labels according to the label allocation request of the multi-protocol label switching client daemon; and updating, in the multi-protocol label switching client daemon, the label pool of the multi-protocol label switching client daemon with the labels allocated by the multi-protocol label switching server daemon and allocating the labels in the updated label pool.

According to yet another aspect, a distributed multi-protocol label switching (MPLS) router is provided, the router comprising: a switching control card including a first label pool having information of all labels allocated in the router stored therein, the switching card adapted to perform allocation of the labels at the first label pool according to a label allocation request and to forward the information on the label allocation in response to receiving the label allocation request; and at least one subscriber line card including a second label pool adapted to receive the information of the label allocation from the switching control card and to store information of the allocated labels and to allocate the labels at the second label pool for itself in response to the label for establishing at least one label switched path being allocated.

According to another aspect, a program storage device, readable by a machine, tangibly embodying a program of instructions executable by the machine is provided to perform a method comprising: determining whether at least one extra label exists in a local label pool having information on allocated labels stored therein and requesting allocation of the labels in preset units in a switching control card in response to a determination that no extra labels exists in response to a label allocation request to establish at least one label switched path in a subscriber line card; allocating the labels at a label pool having information on all labels capable of being allocated in a distributed multi-protocol label switching router stored in preset units therein in response to the label allocation request of the subscriber line card in the switching control card, and transmitting the information of the allocated labels to the subscriber line card; and updating a label pool in the subscriber line card according to information of the allocated labels transmitted from the switching control card, and allocating the labels in the updated label pool in response to the label allocation request in the subscriber line card.

According to another aspect, a program storage device, readable by a machine, tangibly embodying a program of instructions executable by the machine is provided to perform a method comprising:
determining whether at least one extra label exists in a label pool of a multi-protocol label switching client daemon and requesting a multi-protocol label switching server daemon installed on a switching control card to allocate a label in response to a determination that no extra label exists in response to the multi-protocol label switching client daemon installed on a subscriber line card receiving a label allocation request in a line card of the multi-protocol label switching client daemon;
allocating, in the multi-protocol label switching server daemon, the labels stored in a label pool of the multi-protocol label switching server daemon to the corresponding multi-protocol label switching client daemon in page units composed of a plurality of labels according to the label allocation request of the multi-protocol label switching client daemon; and
updating, in the multi-protocol label switching client daemon, the label pool of the multi-protocol label switching client daemon with the labels allocated by the multi-protocol label switching server daemon and allocating the labels in the updated label pool.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a view of a format of an MPLS shim header;

FIG. 2 is a view of a procedure for allocating and managing labels at a distributed multi-protocol label switching (MPLS) router in accordance with an embodiment of the present invention;

FIG. 3 is a view of the flow of an MPLS server daemon allocating and managing labels to and for an MPLS client daemon in accordance with an embodiment of the present invention;

FIG. 4 is a flowchart of an MPLS client daemon allocating and managing labels in accordance with an embodiment of the present invention;

FIG. 5 is a flowchart of an MPLS server daemon allocating and managing labels in accordance with an embodiment of the present invention; and

FIG. 6 is a flowchart of an MPLS client daemon allocating and managing labels in accordance with another embodiment of the present invention.

### DETAILED DESCRIPTION OF THE INVENTION

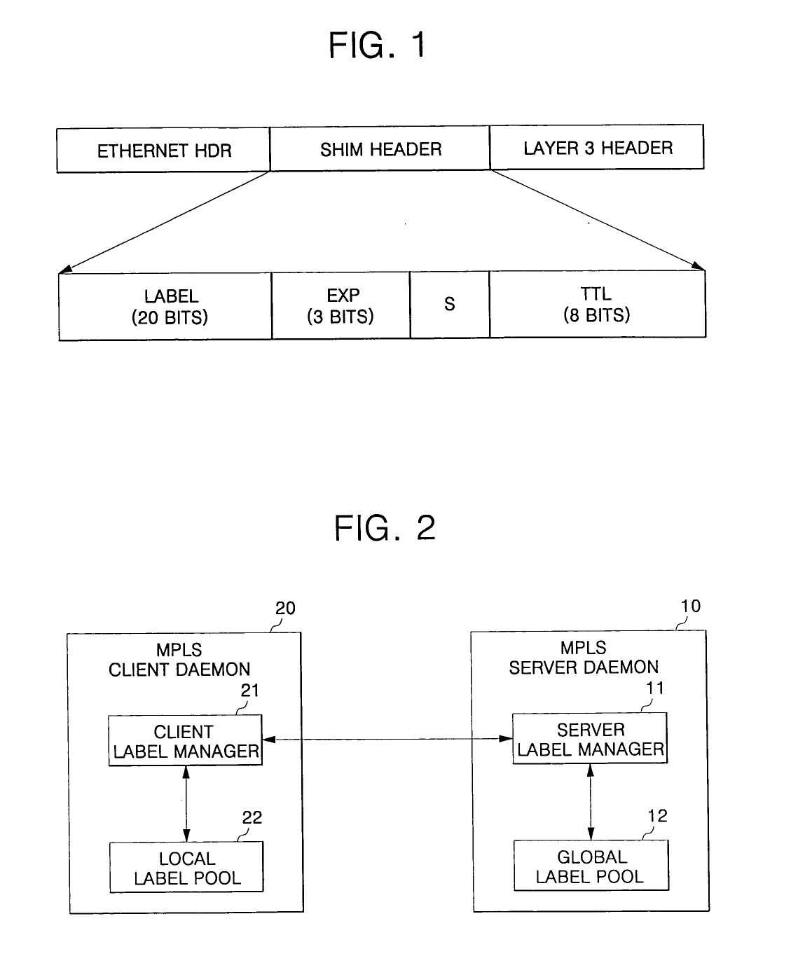

FIG. 1 illustrates a format of an MPLS shim header.

Referring to FIG.1, the MPLS shim header is composed of an Ethernet header, a Shim header and a Layer-3 header, wherein the shim header has 32 bits and consists of Label (20 bits), EXP (Experimental Use, 3 bits), Stack bits (Bottom of Stack, 1 bit) and TTL (Time to Live, 8 bits).

Each label consists of 20 bits and has a range between 0 (zero) and 1048575 (2²⁰−1) which can be used in theory. Thus, except for the range between 0 and 15 which has been already reserved for a special application, the remaining range is between 16 and 1048575, which can be generally allocated by the label manager.

Thus, the label range per line card=1048575/the number of line cards.

For example, for 12 line cards
1048575/12=87381
Line card 0={16,87396} . . .

However, when the label range is allocated in this manner, the LSP defined through a specific subscriber line card can exceed a fixed allocated label range. If so, there is a problem in that the label range must again be allocated.

Furthermore, after the line card is fitted into an empty slot, a subsequent measure to allocate the label again must be taken. Nevertheless, since this subsequent measure is not taken, the label is destined for allocation in such a manner that it must be fixedly divided by the number of the slots into which the line cards may be fitted regardless of whether or not the line card is fitted and whether or not the MPLS protocol is operated. For this reason, there is another problem in that the unused label is allocated.

The present invention will now be described more fully hereinafter with reference to the accompanying drawings, in which embodiments of the present invention are shown. The present invention may, however, be embodied in different forms and should not be construed as being limited to the embodiments set forth herein. Rather, these embodiments are provided so that this disclosure will be thorough and complete, and will fully convey the scope of the present invention to those skilled in the art. In the drawings,like numbers refer to like elements throughout the specification.

FIG. 2 is a view of a procedure for allocating and managing labels at a distributed multi-protocol label switching (MPLS) router in accordance with an embodiment of the present invention.

Referring to FIG. 2, label allocation and management of the distributed MPLS router, i.e. the LSR, are performed through communication between an MPLS server daemon 10 installed on a switching control card (not shown) and an MPLS client daemon 20 installed on a subscriber line card (not shown).

The MPLS server daemon 10 carries out an MPLS-associated Operation, Administration and Maintenance (OAM) function and is installed on the switching control card (not shown). The MPLS server daemon 10 performs operations such as label allocation, Virtual Private Network (VPN) management, Simple Network Management Protocol (SNMP) interaction and so forth.

The MPLS server daemon 10 functions as a label allocation server. For this purpose, the MPLS server daemon 10 includes a server label manager 11 for label allocation and management, and then, when the label allocation is requested from client label managers generated by the MPLS client daemons installed on each subscriber line card, forwards labels stored in its own global label pool 12 in page units.

The MPLS client daemon 20 is installed on the subscriber line card. The MPLS client daemon 20 receives an MPLS-associated Command Line Interface (CLI) command from the MPLS server daemon 10, and performs operations resulting from label allocation, Label Distribution Protocol (LDP) execution or Resource Reservation Protocol (RSVP) execution.

The MPLS client daemon 20 functions as a label allocation client. For this purpose, the MPLS client daemon 20 includes a client label manager 21 for label allocation and management at the subscriber line card, receives the labels from the MPLS server demon 10 installed on the switching control card (not shown) in page units, updates its own local label pool 22, and then, when the label allocation is requested, allocates extra labels stored in the local label pool 22. The label manager 11 of the MPLS server daemon 10 is referred to as a “server label manager,” while the label manager 21 of the MPLS client daemon 20 is referred to as a “client label manager.”

A description follows regarding how the server label manger 11 of the MPLS server daemon 10 allocates and manages the labels.

The server label manager 11 performs and forwards label allocations to the MPLS client daemon 20, together with management of the entire labels. Performing and forwarding label allocations includes allocating and forwarding labels in page units in response to a label allocation request from any MPLS client daemon 20.

Furthermore, management of the labels refers to the labels stored in the global label pool 12 for the server label manager 11 being periodically updated in order to optimally allocate the labels to each MPLS client daemon 20 to which the labels will be allocated by the server label manager 11, thereby managing the labels of the server label manager 11.

Since the label is a limited resource, the server label manager 11 is required to efficiently manage the limited resource. To this end, the server label manager 11 performs periodical scanning with respect to the MPLS client daemons 20 which communicates with itself, and allocates the labels to at least one MPLS client daemon 20. The server label manager 11 determines whether or not unused labels are present. When such unused labels are present, those unused labels are retrieved. The unused labels retrieved from the MPLS client daemons 20 are referred to as “extra labels.”

In order to perform label allocation and management, the server label manager 11 needs to set a unit in which the labels are allocated, when allocating the labels to the client label managers 21 of each MPLS client daemon 20. Specifically, on allocating the labels to any MPLS client daemon 20, the server label manager 11 does not allocate the labels one by one every time a label allocation is requested from the MPLS client daemon 20, but rather allocates in page units. Page units refer to a range of labels which, after the labels have been divided in page units, is the number of labels belonging to one page. For example, it is assumed that 10 labels per page are set. When allocating 10 pages to the MPLS client daemon, the server label manager 11 allocates 100 labels as a whole.

When allocating labels to any MPLS client daemon, the server label manager 11 performs the setting operation indicating that, among all of the labels in its own global label pool 22, the allocated number of labels have been allocated to the corresponding MPLS client daemon.

Thus, the MPLS client daemon, to which the labels have been allocated, stores the allocated labels in its own local label pool. When there is a request for the label allocation to a certain LSP, the MPLS client daemon can set one of the labels stored in its own local label pool. The set label has a unique value throughout all the LSRs.

Hence, the server label manager 11 allocates the labels by matching the labels, which are stored in the global label pool 12, with information of each MPLS client daemon to which the stored labels are allocated. Furthermore, the server label manager 11 retrieves the labels from any MPLS client daemon 20 by releasing the relationship that information of the MPLS client daemon 20 has been matched with respect to the corresponding labels in the global label pool 12 and then deleting the information of the MPLS client daemon 20 as well as information on the corresponding labels from the local label pool of the MPLS client daemon 20.

The number of labels per page is not set by the server label manager 11, but it is set by accessing system information. The server label manager 11 accesses the system information on booting. The system information includes information on the number of labels per page. The system information is set by a system operator and is stored in a database of a switching control board. Therefore, when the switching control board is booted, a value which has been set to a default value in the system information is read out and set. It is natural that, while operating the system, the number of labels per page may be changed and set according to a command of the system operator.

According to a size of the page consisting of the labels which the MPLS server daemon 10 allocates to the MPLS client daemon 20, there may occur a trade-off between the capability to receive/transmit request messages between the server label manager 11 and the client label manager 21 and the capability of the client label manager 21 to allocate the labels for each subscriber line card.

In other words, when the page size is increased, for example, when 10,000 labels per page are to be allocated, the client label manager 21 fetches one page from the server label manager 11 and stores the page, that is, 10,000 labels, in its own local label pool 22. After allocating 10,000 labels stored in its own local label pool 22, the client label manager 21 transmits anew label page request message to the server label manager 11. When the labels stored in the local label pool 22 are allocated by the client label manager 21 for each subscriber line card, a “LABEL_RESP_WAIT” state can be avoided on a state machine. As a result, the LSP can be established at a slightly faster speed for each subscriber line card. However, there is a drawback in that, at a certain subscriber line card, unused labels are excessively retained in its own local label pool 22.

If a small number of labels, for example 10 labels, per page are allocated, the client label manager 21 fetches one page from the global label pool 12 through the server label manager 11 and stores the fetched labels in its own local label pool 22. Whenever the LSP is established by allocating 10 labels stored in its own local label pool 22, the client label manager 21 transmits the label page request message. Thus, whenever an eleventh LSP is set up, the client label manager 21 must wait until it receives a new page in the “LABEL_RESP_WAIT” state, so that a delay may be present. For this reason, it is necessary to properly adjust the page size so as to serve the purpose.

When allocating the labels stored in its own global label pool 12 to the MPLS client daemon 20, the server label manager 11 allocates and manages the labels in the unit of page by adopting the number of the labels per page which is read out the system information.

Furthermore, the server label manager 11 performs communication with the client label manager 21 installed on each line card. With regard to the MPLS client daemon 20 retaining more labels than needed, the server label manager 11 requests the client label manager 21 to retrieve extra labels stored in the corresponding local label pool 22.

As for a method of retrieving the labels, the server label manager 11 performs communication with each client label manager 21 to which it has allocated the labels at a fixed time interval, finds the number of labels stored in the local label pool 22 of the corresponding MPLS client daemon 20, and determines whether or not the number of labels stored in the local label pool 22 of the corresponding MPLS client daemon 20 is more than needed.

As a result of the determination, when a certain MPLS client daemon 20 retains more labels than is needed, the server label manager 11 retrieves the extra labels, leaving the proper number of labels.

A description follows regarding how labels are allocated to the MPLS client daemon 20 and how the allocated labels are managed.

The MPLS client daemon 20 is allocated labels from the MPLS server daemon 10, and manages the allocated labels in its own line card as well. The MPLS client daemon 20 being allocated with the labels means that, when the labels stored in its own local label pool 22 is less than a reference value, the MPLS client daemon 20 requests the MPLS server daemon 10 to allocate the labels, is allocated with the labels in page units, and then allocates the labels to newly generated LSPs.

Furthermore, the MPLS client daemon 20 managing the labels means that, when retaining the labels allocated from MPLS server daemon 10 in its own local label pool 22 to an excessive extent, the MPLS client daemon 20 requests the MPLS server daemon 10 to retrieve extra labels and periodically updates the labels stored in its own local label pool 22 to manage its own retained labels.

Because the labels are limited resources, the client label manager 21 must efficiently manage the limited labels. For this purpose, the MPLS server daemon 10 periodically scans the MPLS client daemon 20 that it is communicating with. When there is a retrieval request for the labels which have been allocated to but not used in any MPLS client daemon 20, the client label manager 21 returns the labels stored in surplus in its own local label pool 22 to the MPLS server daemon 10. In order to carry out the label allocation and management, the client label manager 21 must set a quantity of the labels requested from the MPLS server daemon 10.

In other words, the client label manager 21 does not request the MPLS server daemon 10 to allocate the labels whenever it allocates the labels to new LSPs. Rather, the client label manager 21 requests the MPLS server daemon 10 to allocate a sufficient quantity of labels, is allocated with the requested labels and stores the allocated labels in its own local label pool 22. Then, the client label manager 21 allocates the labels stored in its own local label pool 22 whenever there is a request to allocate the labels to the LSPs. Therefore, when the retained number of labels stored in its own local label pool 22 becomes less than the reference value, the client label manager 21 requests the MPLS server daemon 10 to additionally allocate a desired quantity of labels.

When allocating the labels, the MPLS server daemon 10 allocates the labels in page units. When the client label manager 21 receives the labels from the MPLS server daemon 10, it receives information both on the page for the corresponding label and the label belonging to the page and stores the received information in its own local label pool 22.

Thus, the client label manager 21 sets any one of the labels which it stores when it is requested to allocate the label to a certain LSP, and the set label has a unique value in all routers.

The client label manager 21 allocating labels to the LSPs means matching the labels which the client label manager 21 has stored with information of the LSPs to which the labels are allocated. Furthermore, the client label manager 21 giving the labels back to the MPLS server daemon 10 means deleting information on the corresponding labels from its own local label pool 22.

The number of labels requested from the MPLS server daemon 10 is not set by the client label manager 21, but it is adopted by accessing the system information. The client label manager 21 accesses the system information on booting, wherein the system information contains information on the requested number of labels. The system information is set by a system operator and then stored in a database of its own line card. Thus, when the line card is booted, a value set to the system information as a default value is read and adopted. It is natural that the requested number of the labels may be changed and set according to a command of the system operator during operation of the system.

A trade-off may occur between the capability to receive/transmit request messages between the client label manager 21 and the MPLS server daemon 10 and the capability of the client label manager 21 to allocate the labels according to how the number of labels are requested from the MPLS server daemon 10 by the client label manager 21.

In other words, when the number of the requested labels is increased, for example, when 10,000 labels per request are to be allocated, the client label manager 21 fetches the labels from the server label manager 11 and stores them in its own local label pool 22. After allocating 10,000 labels stored in its own local label pool 22, the client label manager 21 will transmit a new label page request message to the server label manager 11.

In this state, at the subscriber line cards, when the labels stored in the local label pool 22 are allocated by the client label manager 21, a “LABEL_RESP_WAIT” state can be avoided on a state machine, so that the LSP can be established at a slightly faster speed. However, there is a drawback in that the client label manager holds unused labels in its own local label pool 22 to an excessive extent.

If the number of labels requested at a time is set to 10, the client label manager 21 receives the labels from the MPLS server daemon 10 and stores the allocated labels in its own local label pool 22. Whenever the client label manager 21 allocates 10 labels stored in its own local label pool 22 to establish the LSP, the client label manager 21 transmits the label page request message. Thus, whenever an eleventh LSP is set up, the client label manager 21 must wait until it receives a new page in the “LABEL_RESP_WAIT” state. As a result, there is a possibility of a delay. For this reason, it is necessary to properly adjust the requested number of the labels depending on the purpose.

A quantity of labels requested at one time can be set on the basis of a constant reference value for a holding quantity of the labels in the local label pool 22 of the client label manager. For example, when minimum and maximum holding quantities are set, and when a current holding quantity of the labels stored in the local label pool 22 becomes less than the minimum quantity, the client label manager 21 may either request the MPLS server daemon 10 to additionally allocate the labels by a difference between the current holding quantity and the maximum holding quantity, or request a quantity of the labels corresponding to a difference between the minimum holding quantity and the maximum holding quantity from the MPLS server daemon 10.

A procedure of allocating and managing the labels for the MPLS server and client daemons 10 and 20 configured as noted above, is described below.

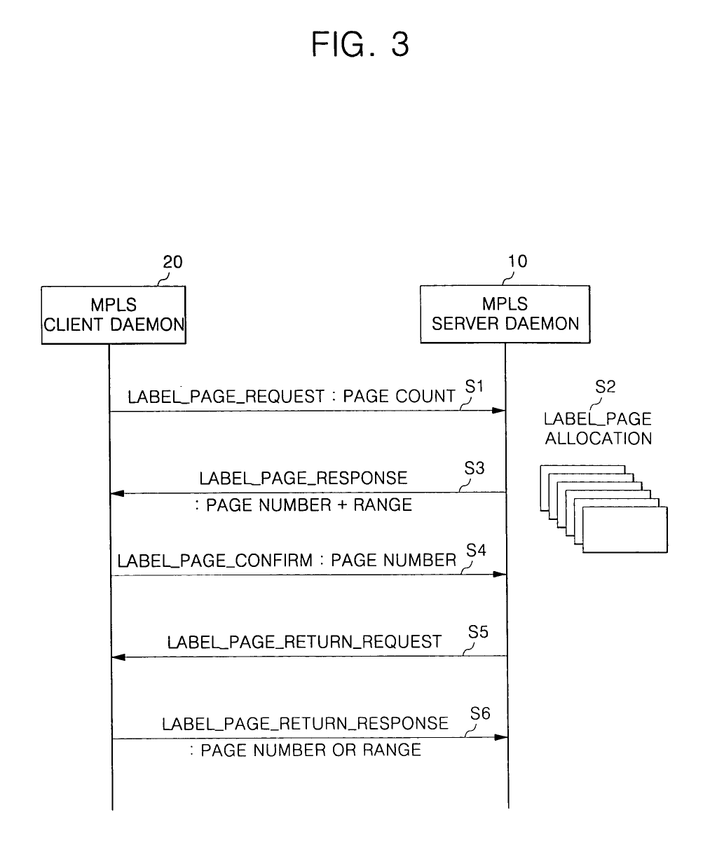

FIG. 3 is a view of an MPLS server daemon allocating and managing labels to and for an MPLS client daemon in accordance with an embodiment of the present invention.

Referring to FIG. 3, on allocating labels for a newly defined LSP, the client label manager 21 of the MPLS client daemon 20 mounted on each subscriber line card searches the local label pool 22 allocated to its own subscriber line card. As a result of the searching, when there are extra labels which are not used, the client label manager allocates the extra labels.

However, when there is no extra label in its own local label pool 22, the client label manager 21 transmits a message, LABEL_PAGE_REQUEST, requesting the labels from the server label manager 11 in the MPLS server daemon 10 and requests a label page (S1).

In order to allocate the labels to one LSP, the client label manager 21 does not request the server label manager 11 to allocate the labels each time, but it requests the server label manager 11 to allocate the labels in page units having a predetermined number of labels. Thus, a load between the client label manager 21 and the server label manager 11 can be reduced, and a capability to allocate the labels can be improved.

When the client label manager 21 requests as many labels as the number of needed pages, the server label manager 11 finds an empty page from its own global label pool 12 and allocates the found empty page number and a value of the label range in the page (S2). Subsequently, the server label manager 11 transmits the page number and the value of the label range in the page as a response message, LABEL_PAGE_RESPONSE, to the client label manager 21 (S3). Then, the client label manager 21 receiving the response message stores the received response message in its own local label pool 22, and transmits a confirmation signal, LABEL_PAGE_CONFIRM, to the server label manager 11 (S4).

The server label manager 11 divides the page according to the number of labels in the page designated by the operator using a label allocation algorithm for allocating the labels in the unit of page, and manages both whether or not the page is used and the allocation state of the page. While doing so, the server label manager 11 transmits a return request message, LABEL_PAGE_RETURN_REQUEST, which periodically requests to return the label page in order to retrieve the extra labels from each MPLS client daemon (S5).

The MPLS client daemons 20 storing the extra labels return the extra labels together with the return response message, LABEL_PAGE_RESPONSE_REQUEST (S6). The MPLS server daemon 10 updates its own global label pool 12 by means of the labels returned from each MPLS client daemon 20, thus properly managing the label resource.

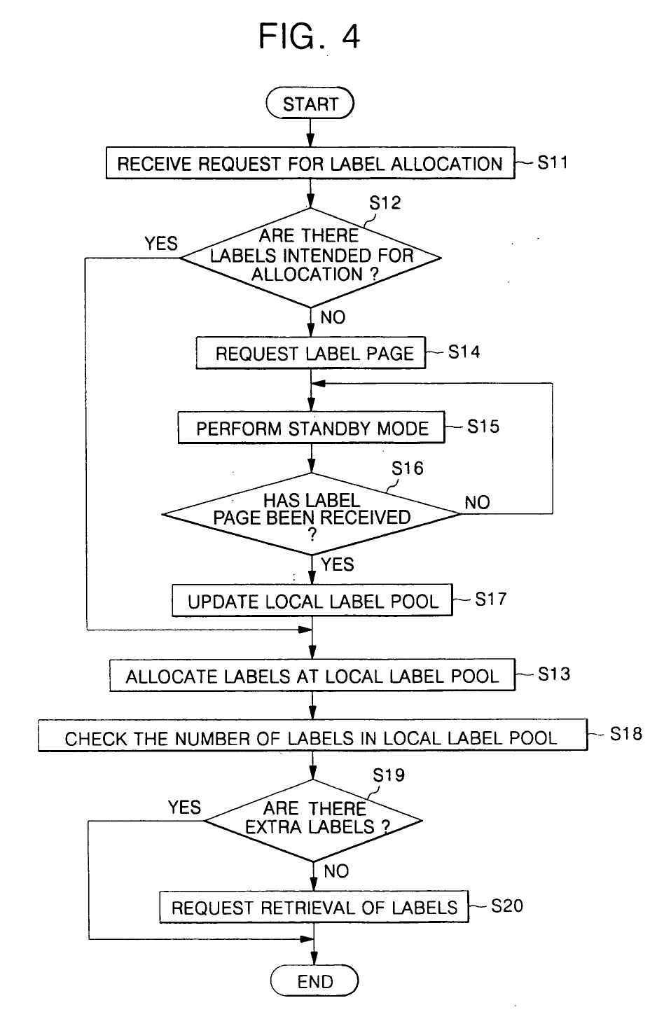

FIG. 4 is a flowchart of an MPLS client daemon allocating and managing labels in accordance with an embodiment of the present invention.

When one of the LSPs is defined within a certain MPLS client daemon, a request for label allocation to the defined LSP is received (SI 1). The client label manager 21 determines whether or not there is an extra label to be allocated to its own local label pool 22(S12). As a result of the determination, when there is the extra label to be allocated, the client label manager 21 allocates the extra label to the corresponding LSP (SI 3). However, when no extra label is left in its own local label pool 22, the client label manager 21 transmits a label page request message which requests a label page from the server label manager 11 of the MPLS server daemon 10 (S14). The client label manager 21 then enters into a standby mode waiting for the requested label page to be transmitted from the MPLS server daemon 10 (S15).

Then, a determination is made as to whether the label page has been received from the MPLS server daemon 10 (S16). When the label page has been received, the client label manager 21 stores the received label page in its own local label pool 22 to update its own local label pool 22 (S17), and allocates the label of the updated local label pool 22 to the LSP requested for the label allocation (S13).

Meanwhile, the client label manager 21 ascertains the number of labels stored in its own label pool 22 (S18), to determine whether or not more labels than necessary are stored in its own label pool 22 (S19).

As a result of the determination, when more labels than necessary are stored in its own label pool 22, the client label manager 21 requests the MPLS server daemon 10 to retrieve the extra labels other than the labels corresponding to a retention reference value (S20). Then, the MPLS server daemon 10 retrieves the extra labels from the MPLS client daemon 20 which has requested retrieval of the extra labels.

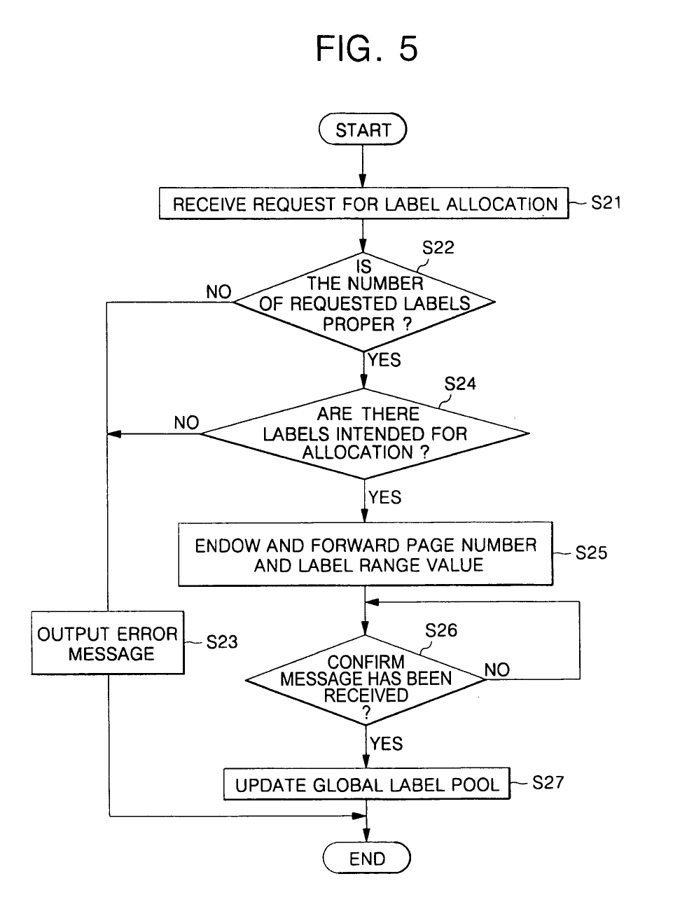

FIG. 5 is a flowchart of an MPLS server daemon allocating and managing labels in accordance with an embodiment of the present invention.

When the server label manager 11 of the MPLS server daemon 10 receives a label page request signal from the MPLS client daemon 20 (S21), the server label manager 11 determines whether or not the number of requested label pages is acceptable (S22). In other words, a determination is made as to whether or not a request command received from the MPLS client daemon 20 falls within a normal range.

When the label page request message received from the MPLS client daemon 20 is not acceptable, the server label manager 11 generates an error message (S23). However, when the label page request message received from the MPLS client daemon 20 is acceptable, the server label manager 11 accesses its own global label pool 12 and determines whether or not there is an unused label page resource to be allocated to the MPLS client daemon 20 (S24).

As a result of the determination, when the number of labels stored in its own global label pool 12 is not sufficient to be allocated to the MPLS client daemon 20, the server label manager 11 generates the error message that it is impossible to allocate the labels (S23).

As a result of the determination, when an unused label page resource is stored in its own global label pool 12, the server label manager 11 endows the unused label page with a page number and a label range value and forwards it to the MPLS client daemon 20 (S25). Then, a determination is made as to whether or not a confirm message has been received, wherein a confirmation message indicates that the label page has been normally received from the MPLS client daemon 20 (S26). When the confirm message has been received, the global label pool 12 is updated (S27).

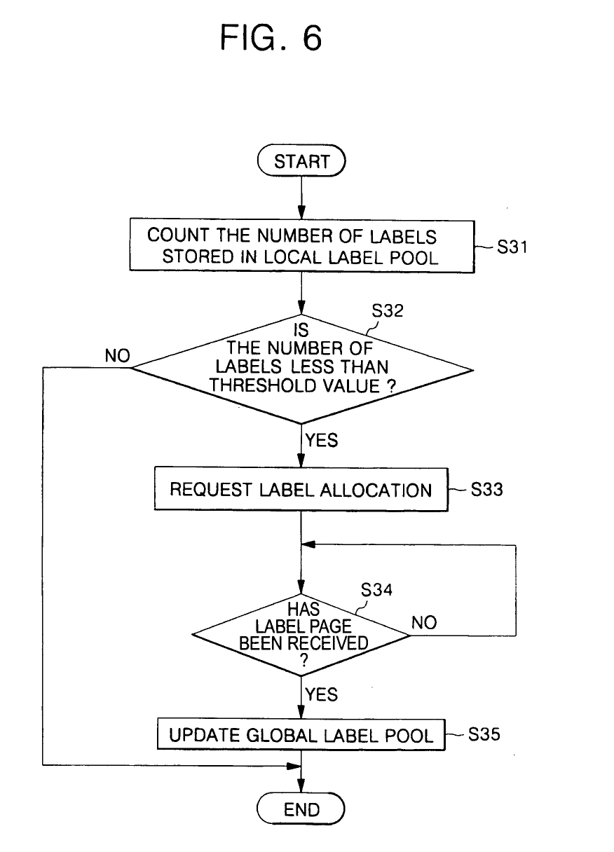

FIG. 6 is a flowchart of an MPLS client daemon allocating and managing labels in accordance with another embodiment of the present invention.

Referring to FIG. 6, the client label manager 21 periodically counts the number of labels stored in its own local label pool 22 regardless of whether or not a request for label allocation to a newly defined LSP is present (S31), and determines whether or not the number of labels stored in its own local label pool 22 is less than a threshold value (S32). As a result of the determination, when the number of labels stored in its own local label pool 22 is less than the threshold value, the client label manager 21 transmits a label page request message to the MPLS server daemon 10 (S33). Then, a determination is made as to whether or not label pages have been received from the MPLS server daemon 10 (S34). When the label pages have been received, the client label manager 21 stores the received label pages in its own local label pool 22 to update its own local label pool 22 (S35).

In other words, the MPLS client daemon 20 endows the number of its own retained labels with a threshold value. Then, when the number of labels falls below the threshold value, label pages are requested from the server label manager 11 by a request of the client label manager 21 for itself rather than a request of an MPLS signaling protocol.

Thus, a “LABEL_RESP_AWAIT” state is carried out from the viewpoint of processing of the MPLS signaling protocol to receive an asynchronous response, and the client label manager 11 returns the labels without a processing delay from the standpoint of a state machine. This not only effectively saves the resources but also improves the performance.

The client label manager 21 drives a label number checker to determine the number of labels which its own local label pool 22 retains. When the number of retained labels is less than a reference value, the label number checker is designed to generate a trigger signal. When the trigger signal has been generated by the label number checker, the client label manager 21 determines that the number of labels retained in its own local label pool 22 is less than the reference value. As a result, the client label manager 21 transmits a request message to request the MPLS server daemon 10 to allocate the labels.

The client label manager 21 determines the number of labels stored in its own local label pool 22 at a constant interval as set forth above. As another method, the client label manager 21 can determine the number of labels which its own local label pool 22 retains whenever the labels are allocated at its own local label pool 22 in order to establish the LSP.

According to the foregoing, the MPLS client daemon 20 manages the number of labels stored in its own local label pool to maintain more than the threshold value at all times. When the MPLS client daemon 20 receives a label allocation request, the MPLS client daemon 20 allocates the labels of the updated local label pool 22 to its own LSP.

According to the present invention, when at least one of the MPLS client daemons installed on each subscriber line card performs communication with the MPLS server daemon installed on the switching control card, and then the MPLS client daemon requests the MPLS server daemon to allocate the labels, the number of labels composing one page is adjusted to the system environment. Thus, it is possible to reduce the time when the MPLS client daemons installed on each subscriber line card are kept in a standby state more than needed in order to receive the labels from the MPLS server daemon, and thus it is possible to establish the LSP in each line card at a faster speed.

Furthermore, the client label manager monitors the number of labels stored in its own local label pool at the MPLS client daemon. When the number of stored labels becomes less than a threshold value, the client label manager requests the MPLS server daemon to allocate the labels for itself without using the signaling protocol. Therefore, the number of labels stored in its own local label pool can be always managed in a flexible manner, so that it is possible to reduce the time when each MPLS client daemon is kept in a standby state in order to receive the labels from the MPLS server daemon.

In addition, the MPLS server daemon scans any MPLS client daemon to which the MPLS server daemon has allocated the labels at a fixed time interval, determines the number of labels which the corresponding MPLS client daemon retains, and retrieves the labels from the MPLS client daemon which has retained more labels then needed. Therefore, it is possible to prevent any MPLS client daemon from retaining unused labels and to prevent the label resources from being wasted, so that it is possible to make use of the limited label resource to the most efficient extent.

1. A method comprising:
determining whether at least one extra label exists in a local label pool having information on allocated labels stored therein and requesting allocation of the labels in preset units in a switching control card in response to a determination that no extra labels exists in response to a label allocation request to establish at least one label switched path in a subscriber line card;
allocating the labels at a label pool having information on all labels capable of being allocated in a distributed multi-protocol label switching router stored in preset units therein in response to the label allocation request of the subscriber line card in the switching control card, and transmitting the information of the allocated labels to the subscriber line card; and
updating a label pool in the subscriber line card according to information of the allocated labels transmitted from the switching control card, and allocating the labels in the updated label pool in response to the label allocation request in the subscriber line card.

2. The method according to claim 1, further comprising:
requesting the subscriber line card to return the label at the switching control card; and
returning the extra label stored in its own label pool in response to the label return request of the switching control card at the subscriber line card.

3. The method according to claim 2, wherein the switching control card periodically requests the subscriber line card to return the label.

4. The method according to claim 1, wherein the switching control card updates its own label pool using the label returned from the subscriber line card.

5. The method according to claim 1, wherein each preset unit is a page unit comprising a plurality of labels per page.

6. The method according to claim 1, further comprising:
requesting the switching control card to retrieve at least one label exceeding a threshold value stored in its own label pool in response to the number of labels stored in its own label pool being counted in the subscriber line card and the counted number of labels exceeding a threshold value; and
returning the label exceeding a threshold value to the switching control card in the subscriber line card and updating its own label pool in response to the switching control card requesting the subscriber line card to return the label exceeding a threshold value according to the retrieval request, .

7. The method according to claim 6, wherein the number of labels stored in its own label pool is periodically counted in the subscriber line card.

8. The method according to claim 6, wherein the number of labels stored in its own label pool is counted in the subscriber line card in response to a label being allocated in own label pool.

9. The method according to claim 1, further comprising:
requesting the switching control card to allocate at least one label in response to the number of labels stored in its own label pool being counted in the subscriber line card and the counted number of labels being less than a threshold value; and
updating its own label pool in the subscriber line card with the allocated label in response to the label being allocated to the subscriber line card by the switching control card.

10. The method according to claim 9, wherein the number of labels stored in its own label pool is periodically counted in the subscriber line card.

11. A method comprising:
determining whether at least one extra label exists in a label pool of a multi-protocol label switching client daemon and requesting a multi-protocol label switching server daemon installed on a switching control card to allocate a label in response to a determination that no extra label exists in response to the multi-protocol label switching client daemon installed on a subscriber line card receiving a label allocation request in a line card of the multi-protocol label switching client daemon;
allocating, in the multi-protocol label switching server daemon, the labels stored in a label pool of the multi-protocol label switching server daemon to the corresponding multi-protocol label switching client daemon in page units composed of a plurality of labels according to the label allocation request of the multi-protocol label switching client daemon; and
updating, in the multi-protocol label switching client daemon, the label pool of the multi-protocol label switching client daemon with the labels allocated by the multi-protocol label switching server daemon and allocating the labels in the updated label pool.

12. The method according to claim 11, further comprising:
the multi-protocol label switching server daemon requesting the multi-protocol label switching client daemon to return the label; and
the multi-protocol label switching client daemon returning the label stored in the label pool of the multi-protocol label switching client daemon in response to the label return request of the multi-protocol label switching server daemon.

13. The method according to claim 11, further comprising:
the multi-protocol label switching client daemon requesting the multi-protocol label switching server daemon to allocate at least one label in response to the number of labels stored in the label pool of the multi-protocol label switching client daemon being counted and the counted number of labels being less than a threshold value; and
the multi-protocol label switching client daemon updating the label pool of the multi-protocol label switching client daemon with the allocated label in response to the multi-protocol label switching server daemon allocating the label to the multi-protocol label switching client daemon.

14. A router comprising:
a switching control card including a first label pool having information of all labels allocated in the router stored therein, the switching card adapted to perform allocation of the labels at the first label pool according to a label allocation request and to forward the information on the label allocation in response to receiving the label allocation request; and
at least one subscriber line card including a second label pool adapted to receive the information of the label allocation from the switching control card and to store information of the allocated labels and to allocate the labels at the second label pool for itself in response to the label for establishing at least one label switched path being allocated.

15. The router according to claim 14, wherein the switching control card is adapted to allocate the labels in preset units in response to the labels being allocated at the first label pool.

16. The router according to claim 15, wherein the preset unit comprises a unit of a page including a plurality of labels per page.

17. The router according to claim 14, wherein the switching control card is adapted to request the subscriber line card to return at least one extra label which the subscriber line card has stored in surplus, and to update the first label pool with the label returned from the subscriber line card.

18. The router according to claim 14, wherein the subscriber line card is adapted to operate a multi-protocol label switching client daemon, the multi-protocol label switching client daemon determining whether at least one extra label is stored in the second label pool of the subscriber line card in response to the label allocation request being received in the subscriber line card, to request the switching control card to allocate at least one label in response to a determination that no extra label exists, to update the second label pool of the subscriber line card with the label allocated from the switching control card, and to allocate the label at the updated second label pool.

19. The router according to claim 18, wherein the switching control card is adapted to operate a multi-protocol label switching server daemon, the multi-protocol label switching server daemon allocating arbitrary labels stored in the first label pool of the switching control card to the corresponding multi-protocol label switching client daemon in units of a page including the plurality of labels according to the label allocation request of the multi-protocol label switching client daemon, and to forward information of the allocated label to the corresponding multi-protocol label switching client daemon.

20. A program storage device, readable by a machine, tangibly embodying a program of instructions executable by the machine to perform a method comprising:
determining whether at least one extra label exists in a local label pool having information on allocated labels stored therein and requesting allocation of the labels in preset units in a switching control card in response to a determination that no extra labels exists in response to a label allocation request to establish at least one label switched path in a subscriber line card;
allocating the labels at a label pool having information on all labels capable of being allocated in a distributed multi-protocol label switching router stored in preset units therein in response to the label allocation request of the subscriber line card in the switching control card, and transmitting the information of the allocated labels to the subscriber line card; and
updating a label pool in the subscriber line card according to information of the allocated labels transmitted from the switching control card, and allocating the labels in the updated label pool in response to the label allocation request in the subscriber line card.

21. A program storage device, readable by a machine, tangibly embodying a program of instructions executable by the machine to perform a method comprising:
determining whether at least one extra label exists in a label pool of a multi-protocol label switching client daemon and requesting a multi-protocol label switching server daemon installed on a switching control card to allocate a label in response to a determination that no extra label exists in response to the multi-protocol label switching client daemon installed on a subscriber line card receiving a label allocation request in a line card of the multi-protocol label switching client daemon;
allocating, in the multi-protocol label switching server daemon, the labels stored in a label pool of the multi-protocol label switching server daemon to the corresponding multi-protocol label switching client daemon in page units composed of a plurality of labels according to the label allocation request of the multi-protocol label switching client daemon; and
updating, in the multi-protocol label switching client daemon, the label pool of the multi-protocol label switching client daemon with the labels allocated by the multi-protocol label switching server daemon and allocating the labels in the updated label pool.
